(19) United States
(12) Patent Application Publication
(10) Pub. No.: US 2008/0200220 A1
(43) Pub. Date: Aug. 21, 2008

(54) METHODS AND DEVICES FOR LIMITING BATTERY POWER CONSUMPTION IN A WIRELESS COMMUNICATION DEVICE

(76) Inventor: Bruce K. JACKSON, Bournemouth (GB)

Correspondence Address: QUALCOMM INCORPORATED, 5775 MOREHOUSE DR., SAN DIEGO, CA, 92121, US

(21) Appl. No.: 11/676,214

(22) Filed: Feb. 16, 2007

(51) Int. Cl. H04B 1/38

(52) U.S. Cl. 455/574

(57) ABSTRACT

Systems, methods and apparatus are provided for limiting power consumption in a wireless communication device. The described aspects provide for power limiting thresholds to reserve power for, or limit power usage by, one or more predetermined applications executable by the wireless communications device. The described aspects are highly user-configurable, allowing a device user and/or a third party to define which applications have a battery power consumption limit or reserve, and the amount of battery power associated with the limit or reserve.

### BACKGROUND

The disclosed aspects relate to wireless communication devices, and more particularly, to systems, methods and apparatus that provide for limiting battery power consumption or reserving battery power consumption for applications executed in a wireless communication device.

Wireless communication devices, such as cellular telephones, portable computers and the like, have rapidly gained in popularity over the past decade. These devices are increasingly becoming multifaceted devices capable of providing a wide-range of functions. For example, today's cellular telephone may also embody computing capabilities, Internet access, electronic mail, text messaging, GPS mapping, digital photographic capability, an audio/MP3 player, video gaming capabilities, video broadcast reception capabilities and the like.

However, many of these wireless device features and functions are power intensive applications that are characterized by high rates of battery power consumption. For example, an audio player application, a video player or gaming application and/or an Internet browser application typically require constant access to the central processing unit (CPU) and, therefore, are considered to be power intensive applications. This power consumption problem is exasperated, in that, the device user typically implements these types of media applications for extended periods of time.

The high rate of battery power depletion of these power intensive applications often limits the effectiveness of a primary function of the wireless communication device. For example, the cellular telephone may not have sufficient power available to carry out placing, receiving or maintaining a communication call. In other examples in which the primary user-focus of the wireless communication device may be network data communication, Internet browsing or the like, the same power problems exist if the power intensive applications rapidly drain the battery power.

In many wireless devices the display is configured with an icon that symbolizes the current state of the battery power. This allows the user to be aware of the amount of battery power currently existing in the device. However, when a user is implementing a power-intensive application, such as an audio player or video player application, they are often oblivious to the displayed icon and/or the current state of available battery power. In many instances, the user will continue to use the power-intensive application, thereby depleting the battery power to such a level that use of another device function is impaired.

Therefore, a need exists to insure that less essential, power-intensive applications that are executed on a wireless communication device do not deplete the battery power of the device to such a level that it renders the device incapable of providing primary device functions, such as communication call functions, data transmission functions or the like. In addition, the desired methods and/or mechanisms should allow for a wide range of user configuration, allowing for a user to determine which applications require power consumption limitations and/or which applications are deemed essential and require power to be reserved for those user determined essential functions.

### SUMMARY

Thus, present aspects provide for methods, apparatus and systems for limiting the amount of battery power consumed by one or more predetermined applications, such as media player applications, and/or reserving battery power for user-designated or device specific essential applications, such as communication call applications, data transfer applications or the like. The present aspects are highly user-configurable, in that the user can define which applications require limiting battery power use and the amount of power that should be limited, and/or which applications require reserving battery power and the amount of battery power that should be reserved. In this regard, for example, the present aspects prevent power intensive applications from consuming battery power to a level at which certain device applications, such as communication call applications or the like, no longer have sufficient power to accommodate their execution.

In addition, the present aspects provide for the limiting the amount of battery power consumption consumed by some applications and/or reserving battery power for other applications based on associated physical environmental conditions, such as the geographic location of the device, the time of day or any other associated condition identifiable by the device.

One aspect is provided for by a method for limiting power consumption in a wireless communication device. The method includes receiving at least one battery power threshold. Each battery power threshold is associated with at least one of a plurality of applications executable on the wireless communication device. The method additionally includes storing the at least one battery power threshold in wireless communication device memory, monitoring a battery power level to determine if the battery power level meets the at least one battery power threshold, and disabling a predetermined one of the plurality of applications, while not shutting down the wireless communication device, if monitoring of the battery power level determines that the at least one battery power threshold has been met. In some cases, the battery power threshold may be associated with any application, such as a power intensive application, for example, an audio player application, a video player or gaming application, an Internet browser application or the like. Alternatively or in addition, the battery power threshold may be associated with an application associated with a power reserve, for example, a call communication application, a data transfer application or the like.

In one aspect of the aforementioned method, receiving at least one battery power threshold may further include receiving at least one reserve power threshold. Each reserve power threshold is associated with a corresponding application having the power reserve and is executable on the wireless communication device. In such an aspect, disabling a predetermined one of the plurality of applications, while not shutting down the wireless communication device, may further include disabling any currently executing application on the wireless communication device except for the application having the power reserve and any applications that support that application, while not shutting down the wireless device, if monitoring of the battery power level determines that a corresponding reserve power threshold has been met. Additionally, such aspects may provide for prohibiting an initiation of execution of all applications on the wireless device except for the application having the power reserve and any of the applications that support that application until wireless device power exceeds the reserve power threshold.

In one aspect of the method monitoring the battery power level may further involve polling of a battery power monitor to determine the battery power level. In another aspect of the method of disabling a predetermined one of the plurality of applications, while not shutting down the wireless communication device, may further entail communicating an interrupt message from a battery power monitor to the at least one of the applications if monitoring of the battery power level determines that the battery power threshold has been met. Additionally, the method may include prohibiting starting the one or more applications that have been disabled until wireless device power exceeds the battery power threshold, and/or adjusting at least one battery power threshold to enable the at least one application that has been previously disabled.

In certain aspects of the method, receiving at least one battery power threshold may further include receiving at least one battery power threshold and one or more associated physical environmental conditions, such as geographic locations, time periods or the like. In this regard, a battery power threshold may be associated with at least one application and at least one physical environmental condition. In such aspects, disabling may further include disabling a predetermined one of the plurality of applications if monitoring of the battery power level determines that at least one of the battery power thresholds has been met and the associated physical environmental condition exists.

Another aspect is defined by at least one processor operable on a wireless communication device. The processor is configured to perform the action of receiving at least one battery power threshold. Each battery power threshold is associated with at least one of a plurality of applications executable on the wireless communication device. The processor is additionally configured to perform the actions of storing the at least one battery power threshold in wireless communication device memory, monitoring a battery power level to determine if the battery power level meets the at least one battery power threshold, and disabling a predetermined one of the plurality of applications, while not shutting down the wireless communication device, if monitoring of the battery power level determines that the at least one battery power threshold has been met.

Additionally, a further aspect is provided for by a computer program product that includes a computer readable medium. The computer readable medium includes a first set of codes for causing a computer to receive at least one battery power threshold. Each battery power threshold is associated with at least one of a plurality of applications executable on the wireless communication device. The computer readable medium further includes a second set of codes for causing the computer to store the battery power thresholds in wireless communication device memory, a third set of codes for causing the computer to monitor a battery power level of the wireless communication device to determine if the battery power level meets the at least one battery power threshold, and a fourth set of codes for causing the computer to disable a predetermined one of the plurality of applications, while not shutting down the wireless communication device, if monitoring of the battery power level determines that the at least one battery power threshold has been met.

A wireless communication device defines another aspect. The wireless communication device includes means for receiving at least one battery power threshold. Each battery power threshold is associated with at least one of a plurality of applications executable on the wireless communication device. The wireless communication device further includes means for storing the battery power threshold in wireless communication device memory, means for monitoring a battery power level of the wireless communication device to determine if the battery power level meets the at battery power threshold, and means for disabling a predetermined one of the plurality of applications, while not shutting down the wireless communication device, if monitoring of the battery power level determines that battery power level meets the battery power threshold.

In another aspect of a wireless communication device, the device includes a computer platform having a processor and a memory. The device further includes a plurality of applications stored in the memory and executable by the processor, and a battery power monitor executable by the processor and operable to monitor a battery power level in the wireless communication device. The device further includes a battery power threshold module in communication with the battery power monitor, stored in the memory and executable by the processor. The battery power threshold module is operable to receive a battery power threshold associated with at least one of the plurality of applications, determine if the battery power level meets the battery power threshold, and disable a predetermined one of the plurality of applications, while not shutting down the device, if the battery power level meets the battery power threshold. For example, the predetermined one of the plurality of applications may include any power intensive application such as an audio player application, a video player or gaming application and the like, and/or any essential/critical application such as a communication call application, a network data transfer application, an Internet browser application or the like.

In one aspect of the device the battery power threshold module is further operable to receive a reserve power threshold associated with an application having a power reserve, determine if the reserve power threshold is met, and disable, while not shutting down the wireless communication device, any currently executing application on the wireless communication device, except for the application having the power reserve and any applications that support the application having the power reserve, if monitoring of the battery power level determines that a corresponding reserve power threshold has been met. Further, the battery power threshold module may be further operable to prohibit execution of all applications on the wireless device except for the application having the power reserve and any of the applications that support the application having the power reserve until wireless device battery power level exceeds the reserve power threshold.

In one aspect of the device, the battery power threshold module is further operable for polling the battery power monitor to determine the battery power level and/or is operable to receive an interrupt message from the battery power monitor if monitoring of the battery power level determines that the threshold has been met. The battery power threshold module may be further operable to provide for readjustment of the battery power threshold to reinitiate the predetermined one of the plurality of applications that has been previously disabled.

The wireless communication device may additionally include a environmental condition monitoring device, such as a position locating device, a clock device or the like, operable to monitor an environmental condition. In such aspects, the battery power threshold module may be further operable to receive a predetermined environmental condition, such as a predetermined location, a predetermined time or the like, associated with the battery power threshold, and disable the predetermined one of the plurality of applications, while not shutting down the device, if the batter power threshold and the associated environmental condition are determined to be met.

The present aspects provide for limiting power use by applications executed on a wireless communication device and/or reserving power for applications executed on a wireless device. Further, the present aspects provide methods, apparatus and systems that are highly user-configurable, in that the user can define which applications require limiting battery power consumption and the amount of power that should be limited and/or which applications require reserving battery power and the amount of battery power that should be reserved. In this regard, the present aspects prevent one or more predetermined applications, such as applications the user may deem unessential, from reducing battery power to a level at which other predetermined device applications or functions, such as applications the user may deem more essential, for example, communication call applications or the like, no longer have sufficient power to accommodate the execution of the application or function.

### BRIEF DESCRIPTION OF THE DRAWINGS

FIG. 1 is a simplified block diagram of a wireless communication device for implementing battery power consumption limits and/or reserve power limits, in accordance with an aspect;

FIG. 2 is a detailed block diagram of a wireless communication device for implementing battery power consumption limits and/or reserve power limits, in accordance with an aspect;

FIG. 3 is a message flow diagram detailing a method for limiting battery power consumption in a wireless device, in accordance with an aspect;

FIG. 4 is a message flow diagram detailing a method for limiting battery power consumption in a wireless device, in accordance with an aspect;

FIG. 5 is schematic representation of a wireless device display that provides user-configurable limitations on battery power consumption for a prescribed application, according to another aspect;

FIG. 6 is schematic representation of a wireless device display that provides user-configurable reserve battery power limits for a prescribed application, according to another aspect; and

FIG. 7 is a flow diagram of a method for limiting battery power consumption in a wireless communication device, in accordance with an aspect.

### DETAILED DESCRIPTION

The present devices, apparatus, methods, computer-readable media and processors now will be described more fully hereinafter with reference to the accompanying drawings, in which aspects of the invention are shown. The described aspects, however, may be embodied in many different forms and should not be construed as limited to the aspects set forth herein; rather, these aspects are provided so that this disclosure will be thorough and complete, and will fully convey the scope of the invention to those skilled in the art. Like numbers refer to like elements throughout.

The various aspects for limiting battery power consumption are described herein in connection with a wireless communication device. A wireless communication device can also be called a subscriber station, a subscriber unit, mobile station, mobile, remote station, access point, remote terminal, access terminal, user terminal, user agent, a user device, or user equipment. A wireless communication device may be a cellular telephone, a cordless telephone, a Session Initiation Protocol (SIP) phone, a wireless local loop (WLL) station, a personal digital assistant (PDA), a handheld device having wireless connection capability, or any other processing device connected to a wireless modem.

The described aspects provide for methods, apparatus and systems for limiting battery power consumption in a wireless communication device. In some aspects, at least one of a plurality of applications resident on and are executable by a wireless communication device has an associated power level threshold, which may act to limit the amount of power usage of, or reserve an amount of power for, the respective application. For example, in one usage case, the predetermined application may include a power intensive application such as an audio player application, a video player or gaming application or the like, which may be limited to a predefined battery power usage threshold. For example, such a threshold may be typically defined as a percentage of a maximum battery power level. Once the threshold is met, the predetermined application is disabled. Further, for example, disabling the predetermined application includes shutting down the application and/or prohibiting the application from being initiated until the battery power level is restored to a level that exceeds the predefined threshold. In another use case, the predetermined application may include a user-defined or third party-defined essential or critical application, such as a communication call application, a network data transfer application or the like, for which a predetermined amount or reserve of battery power is provided. In this use case, for example, a predefined battery power threshold is assigned to a given application, and once the threshold is met, all other applications on the device, except for the given or essential application and applications supporting the given or essential application, are disabled. Thus, the present aspects allow for controlling the usage of battery power on a wireless communication device.

The described aspects are highly user-configurable. For example, a user can determine which applications being executed on the wireless device have power limitations, such as power intensive applications, and which applications have reserve power, such as essential or critical applications.

In addition, a user can configure the battery power thresholds, e.g., the amount or percentage of battery power level at which an application will be disabled and/or the amount or percentage of battery power level reserved for a given application. Also, a user may choose to reconfigure the applications on-the-fly, for example, by disabling the power limiting or power reserving functions or changing the assigned threshold limits. In other alternatives, the threshold may be determined by a third party, such as a network carrier, a provider of a given application, a manufacturer of the device or an associated device component, etc. For example, an application may be supplied to the user with a predetermined threshold.

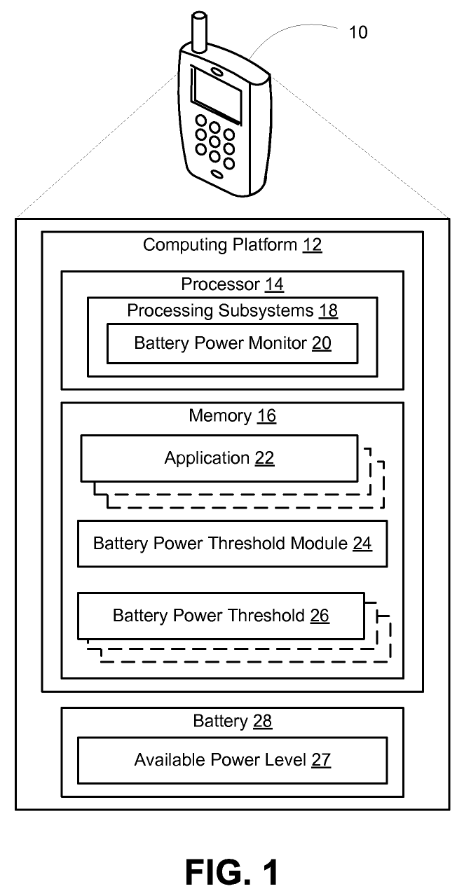

Referring to FIG. 1, a block diagram is depicted of a wireless communication device 10 that manages battery power consumption in accordance with present aspects. The wireless communication device 10 includes a computer platform 12 having a processor 14 and a memory 16. The processor includes various processing subsystems 18. Including amongst the various processing subsystems is battery power monitor 20, which is operable to determine the current amount of available power level 27 from battery 28 and to provide current battery power amount information to other applications and modules on the wireless communication device.

The memory 16 of wireless communication device 10 includes one or more applications 22 that are executable on the wireless device. Application 22 may include one or more power-intensive applications, such as audio/MP3 player applications, video player applications, video gaming applications, Internet browsing applications and the like. Power intensive applications are characterized as those applications that require relatively large amounts of processing time, and/or use a large percentage of processing resources, and/or are typically used for extended periods of time. In addition, application 22 may include one or more device-specific or user-defined essential or critical applications. For example, in those aspects in which the wireless communication device is a cellular telephone the device itself likely dictates that communication call applications and those applications associated with a communication call are deemed essential or critical applications. In another example, the user of the device may have special needs or interests that require the manufacturer, the service provider and/or the user to predefine any application(s) as being essential or critical. For example, the manufacturer, the service provider or the user may define the Internet browser application, the video gaming application and/or any other application the manufacturer, the service provider or the user so desires as an essential/critical application.

It should be understood that power intensive applications and user-defined essential or critical applications are merely an example of one possible aspect. In general, the described aspects allow for the setting of a power usage threshold or a power reserve threshold for one or more applications, regardless of a power consumption nature and/or a perceived or actual functional importance of the respective application.

Memory 16 of wireless communication device also includes a battery power threshold module 24 that is operable to receive at least one battery power threshold 26, store the battery power threshold(s) 26 in device memory and monitor the currently available batter power level 27. If monitoring of the battery power level 27 determines that a threshold has been met, then battery power threshold module 24 is operable to disable at least one application while not shutting down the wireless communication device. By not shutting down the wireless communication device certain basic device functionality, such as the device operating system and predetermined applications, remain operable.

In some aspects, the battery power threshold module 24 may be configured within device firmware or some relatively low operational level of the device so as to allow for control of a plurality of applications, or all applications, executed on the wireless communication device. For example, battery power threshold module 24 configured within device firmware may be configured to receive a single threshold that limits battery power consumption for all non-essential, non-critical applications, which in one case may include non-communication call applications. Alternatively, or in addition, a single threshold may set a power reserve limit for all predefined essential or critical applications, which in one case may include a voice call application. In another example, battery power threshold module 24 configured within device firmware may be configured to receive multiple thresholds, with each threshold limiting power for a predetermined application. Alternatively, or in addition, each one of multiple thresholds may set a reserve amount of power for a predetermined application.

In other aspects, battery power threshold module 24 may be configured as an option within one or more applications. For example, battery power threshold module 24 may be a component within one or more applications, such as power-intensive applications, including an audio player application, a video player or gaming application, an Internet browser application or the like. In this regard, each application so configured can receive a battery power limit threshold that will disable the respective application when the corresponding threshold is met. Additionally, battery power threshold module 24 may be configured within one or more applications, including essential/critical applications, such as communication call applications, network data transfer applications or any other application that is deemed essential by the user, the service provider or the device manufacturer. In this regard, each application so configured can receive a battery power reserve threshold that will disable all other applications on the device, except for the application so configured and any applications that support this application, when the reserve battery power threshold is met.

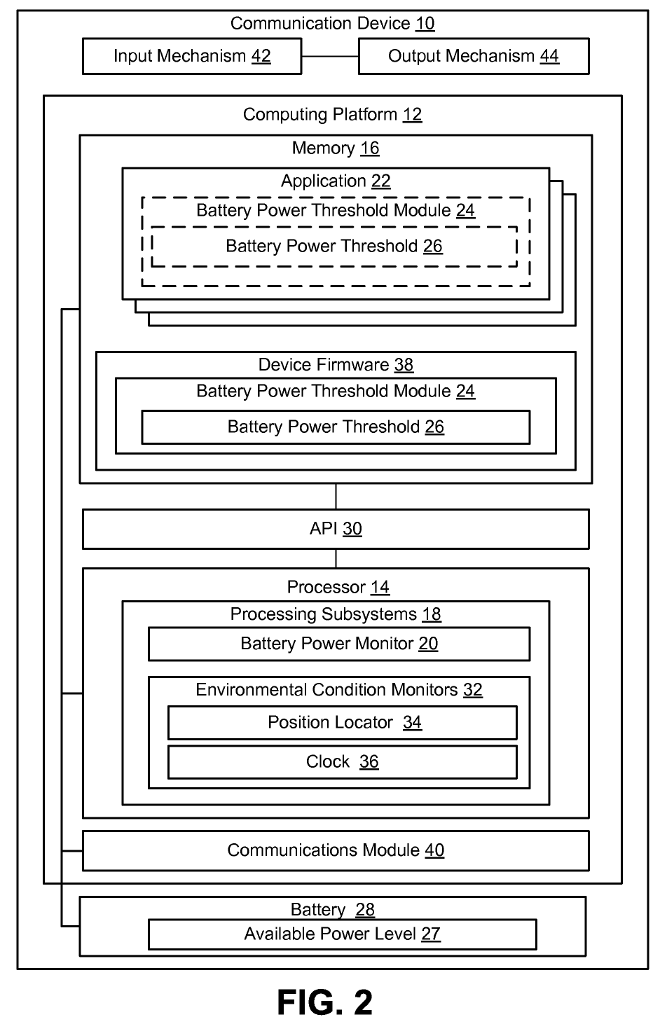

Referring to FIG. 2, according to one aspect, a detailed block diagram representation of a wireless communication device 10 operable for limiting battery power consumption is depicted. As previously noted, the wireless communication device 10 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 10 includes computer platform 12 that can transmit data across a wireless network, and that can receive and execute routines and applications. Computer platform 12 includes memory 16, which may comprise volatile and nonvolatile memory such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computer platform 12 also includes a processing engine 14, which may be an application-specific integrated circuit (“ASIC”), or other chipset, processor, logic circuit, or other data processing device. Processing engine 14 or other processor such as ASIC may execute an application programming interface (“API”) layer 30 that interfaces with any resident programs, such as battery power threshold module 24, stored in the memory 16 of the wireless device 10. API 30 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processing engine 14 includes various processing subsystems 18 embodied in hardware, firmware, software, and combinations thereof, that enable the functionality of communication device 10 and the operability of the communication device on a wireless network. For example, processing subsystems 18 allow for initiating and maintaining communications, and exchanging data, with other networked devices. In aspects in which the communication device is defined as a cellular telephone the communications processing engine 14 may additionally include one or a combination of processing subsystems 18, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity).

For the disclosed aspects, processing subsystems 18 of processing engine 14 includes a battery power monitor 20 operable for monitoring the current available power level 27 in battery 28 and providing battery power level information to the battery power threshold module 24.

In alternate aspects, processing subsystems 18 may include environmental condition monitors 32, such as geographic position locator 34, clock 36 and the like. In some aspects, environmental condition monitors 32 are used to further monitor defined conditions under which the battery power limit thresholds or reserve thresholds are applicable. For example, the battery power limit thresholds or reserve thresholds may be configured to apply to predetermined geographic locations, such as; locations where other power options or alternate calling means are not feasible. In this regard, the thresholds may be configured to be applicable when the wireless device is located outside of the home or the workplace (e.g., places where dc power options are readily available) or any other place designated by the user. In another example, the battery power limit thresholds or reserve thresholds may be configured to apply during predetermined time periods, such as between 7 am and 6 pm or between 8 pm and 5 am, etc.

The memory 16 of computer platform 12 includes battery power threshold module 24 that is operable to receive at least one battery power threshold 26, store the battery power threshold(s) 26 in device memory and monitor the currently available power level 27. If monitoring of the battery power level 27 determines that a threshold has been met, then battery power threshold module 24 is operable to disable, at least one application, while not shutting down the wireless communication device. By not shutting down the wireless communication device certain basic device functionality, such as the device operating system and predetermined applications, remain operable. As previously noted, and shown in FIG. 2, the battery power threshold module may reside in device firmware 38 and/or in one or more predefined applications 22.

It should be noted that a battery power threshold is defined by a value and a condition. The threshold value may be a numeric percentage value, for example, the percentage of battery power currently available on the wireless device. The threshold conditions may include “less than,” “greater than,” “equal to,” “less than and equal to,” “greater than or equal to” or the like. For the sake of clarity, the term “meets” a threshold is used herein to define the instance in which a measured value exceeds, equals or falls short of the predefined value. In some aspects, the term “meets” a threshold is used herein to define the instance in which the currently measured battery power level, typically defined as a percentage of the maximum battery power, equals or falls below the predefined threshold value.

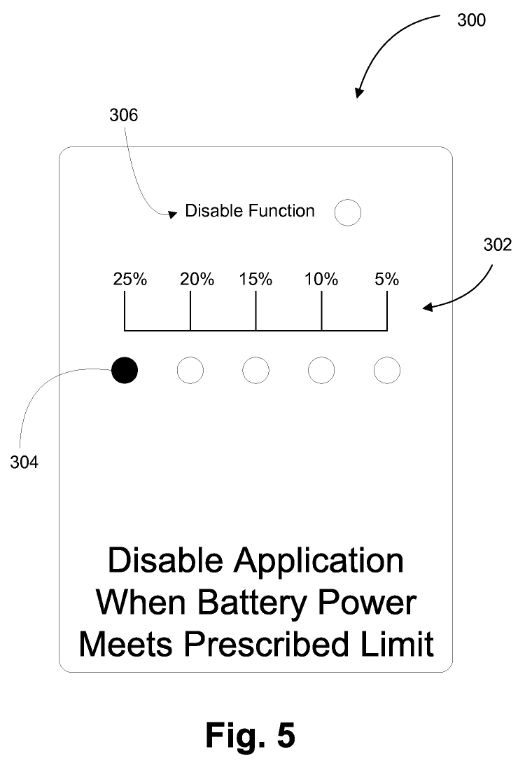

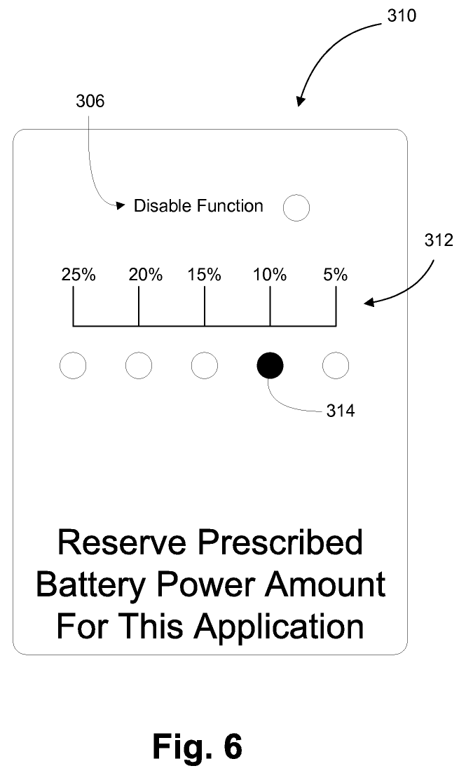

The battery power threshold module 24 may be configured to provide a user-interface, such as a displayable graphical user interface or the like, that provides for user input of the one or more battery power thresholds. See FIGS. 5 and 6 and the related discussion. In those aspects in which the battery power threshold module 24 resides in device firmware 38, the user interface may be available through the device settings/options/parameters portion of the wireless communication device. In those aspects in which the battery power threshold module 24 resides in one or more applications 22, the user interface may be available through application settings/options/parameters portion of the specified application. In those aspects in which the battery power threshold is user-configurable, the user may select the threshold value, such as minimum percentage of available battery power level 27 that will trigger disabling of applications. Additionally, in those aspects in which environmental condition options are available, the user may select any available environmental conditions to which the battery power threshold applies, such as a geographic location, a time period or the like. In alternate aspects, the battery power thresholds 26 may be preconfigured by the device and/or application manufacturer or, alternatively, the device may include logic (not shown in FIG. 2) that determines appropriate battery power thresholds 26 based on usage patterns for predetermined applications.

Computer platform 12 may further include communications module 40 embodied in hardware, firmware, software, and combinations thereof, that enables communications among the various components of the communication device 10, as well as between the communication device 10 and a wireless network. In described aspects, the communication module enables the communication of all correspondence between the processing subsytems 18, API 30, firmware 38, and applications 22. The communication module 40 may include the requisite hardware, firmware, software and/or combinations thereof for establishing a wireless or wired network communication connection.

Additionally, communication device 10 has input mechanism 42 for generating inputs into communication device, and output mechanism 44 for generating information for consumption by the user of the communication device. For example, input mechanism 42 may include a mechanism such as a key or keyboard, a mouse, a touch-screen display, a microphone, etc. In certain aspects, the input mechanisms 42 provides for user input to activate an application on the communication device and input user configurable battery power thresholds or other configurable parameters related to battery power monitoring. Further, for example, output mechanism 44 may include a display, an audio speaker, a haptic feedback mechanism, etc. In one aspect, the output mechanism may include a display for displaying visual notification that a threshold has been met and that corresponding applications are being disabled and/or an audio speaker to provide an audible notification that a threshold has been met and that corresponding applications are being disabled.

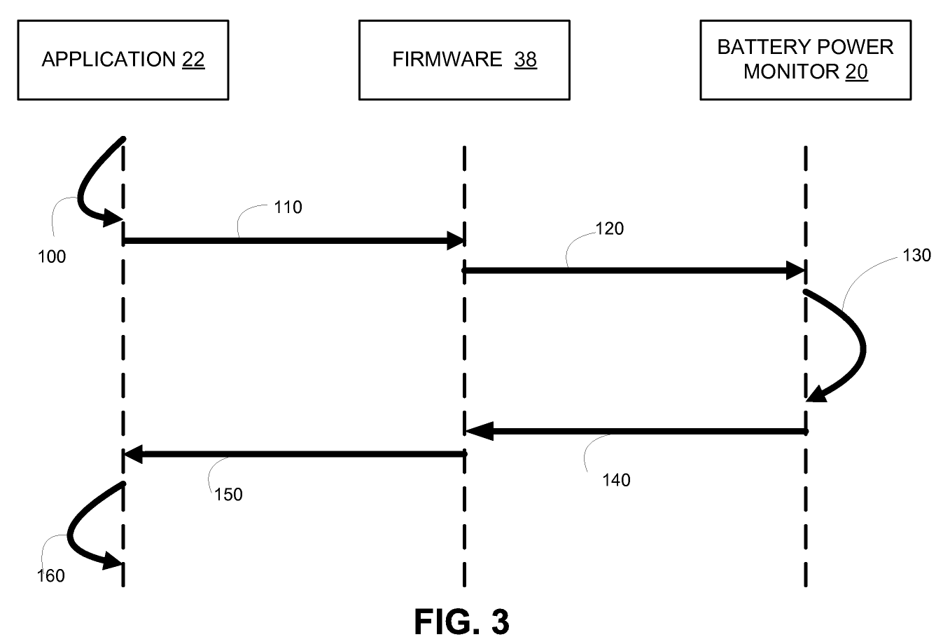

FIG. 3 is a message flow diagram of a system for battery power threshold monitoring in accordance with an aspect. At Event 100, a user configures a threshold (26) in an application (22) or the manufacturer or service provider pre-configures a threshold in an application (22). As previously noted the application may be a power-intensive application, such as an audio player application, a video player application, a video gaming application, an Internet browser application or the like. In this instance, the threshold (26) may define the battery power level (27) at which the application is disabled from further use. Additionally, the application may be a device critical or essential application, such as a communication call application, a network data communication application or the like. In this instance, the threshold (26) may define the battery power level (27) at which all other applications on the device, except this critical/essential application and all applications related to this critical/essential application, are disabled from further use. In alternate aspects, other conditions related to the threshold, such as geographic location, time and the like, may also be configured in conjunction with the configuration of the threshold.

At Event 110, the battery power threshold (26), and any related condition, is communicated from the application (22) through the system firmware (38) and at Event 120, the system firmware sends a communication to the battery power monitor (20) to set the battery power threshold. At Event 130, the battery power monitor (20) monitors the power level of the battery (28) and, at Event 140, when the battery power threshold is met a communication is sent from the battery power monitor (20) to the firmware (38). At Event 150, the firmware (38) sends a “battery power threshold met” communication to the application (22) and to any other affected applications. In some aspects, in which the threshold is configured within a power intensive application (22), the “battery power threshold met” communication may be communicated back to the application for which the threshold was designated (e.g., the power-intensive application). In other aspects, in which the threshold is configured within a critical or essential application (22), the “battery power threshold met” communication may be communicated to all other applications, except the critical/essential application and those applications related to the critical/essential application.

In response to receiving the “battery threshold met” communication the application (22), is disabled, at Event 160, or a notification is sent to the user that the application will be disabled unless the user takes the necessary action to prevent disablement, such as reconfiguring the threshold, increasing the battery power level or implementing another power source. Disabling an application includes shutting down a currently used application and/or prohibiting the subsequent launching of the application.

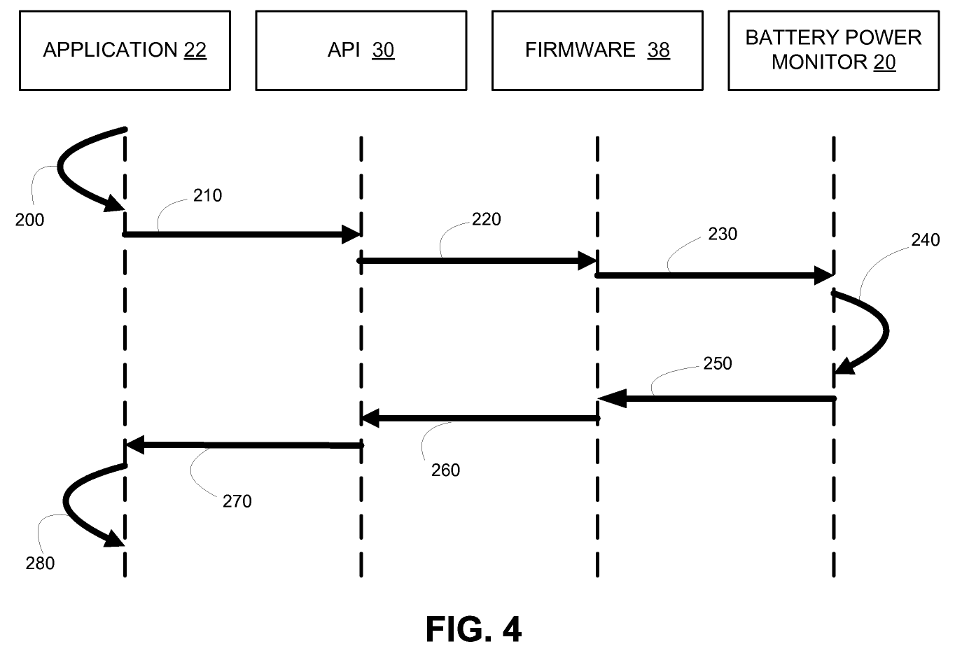

FIG. 4 is another message flow diagram of a system for battery power threshold monitoring that incorporates an application programming interface (API), in accordance with an aspect. At Event 200, a user configures a threshold (26) and any related conditions in an application (22) or the manufacturer or service provider pre-configures a threshold in an application (22). At Event 210, the battery power threshold (26), and any related conditions, is communicated from the application (22) to the system API (30). At Event 220, the API (30) forwards the battery power threshold communication to the system firmware (38) and at Event 230, the system firmware sends a communication to the battery power monitor (20) to set the battery power threshold.

At Event 240, the battery power monitor (20) monitors the power level of the battery (28) and, at Event 250, when the battery power threshold is met a communication is sent from the battery power monitor (20) to the firmware (38). At Event 260, the firmware (38) forwards the “battery power threshold met” communication to the system API (30) and, at Event 270, the firmware (38) sends a “battery power threshold met” communication to the application (22) and to any other affected applications. As previously noted, in some aspects, in which the threshold is configured within a power intensive application (22), the “battery power threshold met” communication may be communicated back to the application for which the threshold was designated (e.g., the power-intensive application). In other aspects, in which the threshold is configured within a critical or essential application (22), the “battery power threshold met” communication may be communicated to all other applications, except the critical/essential application and those applications related to the critical/essential application.

In response to receiving the “battery threshold met” communication the application (22), at Event 280, is disabled or a notification is sent to the user that the application will be disabled unless the user takes the necessary action to prevent disablement, such as reconfiguring the threshold, increasing the battery power level or implementing another power source. Disabling an application includes shutting down a currently used application and/or prohibiting the subsequent launching of the application.

FIG. 5 provides an example of a user-interface 300 for configuring a battery power threshold associated with a power intensive application, such as an audio/video player application, a video gaming application, an Internet browsing application or the like, in accordance with an embodiment of the present invention. The illustrated user-interface 300 is typically accessed through the settings/parameters options of an application and is displayed on the wireless communication device display. The illustrated example allows for the user to choose from amongst five battery power thresholds 302, defined in terms of a percentage of the maximum battery power. For example, the user may choose from amongst 25%, 20%, 15%, 10% or 5% of the maximum battery power level. If, for example, the user provides an indication 304, as illustrated in FIG. 5, of the selection of the 25% battery power threshold, the application associated with the battery power threshold module may be disabled or the user may be notified of an impending disablement when the battery power level is equal to or below about 25% of the maximum battery power. As illustrated, the user interface 300 may also provide a disable function 306 for the user to disable the battery power threshold module, thus allowing the application to be executed regardless of the amount of available battery power. The illustrated user-interface provides for the user to access the power intensive application and re-configure the battery power threshold as need and/or as the situation dictates.

FIG. 6 provides another example of a user-interface 310 for configuring a battery power threshold within a critical and/or essential application, such as a communication call application or the like, in accordance with an embodiment of the present invention. The illustrated user-interface 310 is typically accessed through the settings/parameters options with an application and is displayed on the wireless communication device display. The illustrated example allows for the user to choose from amongst five battery power thresholds 312, defined in terms of a percentage of the maximum battery power. For example, the user may choose from amongst 25%, 20%, 15%, 10% or 5% of the maximum battery power. If, for example, the user provides indication 314, as illustrated in FIG. 5, of the selection of the 10% battery power threshold, all other applications on the device, except for the application for which power is being reserved and any applications related to this application, may be disabled or the user may be notified of the impending disablement of all other applications when the battery power level is equal to or below about 10% of the maximum battery power. As illustrated, the user interface 310 may also provide disable function 316 for the user to disable the battery power threshold module, thus allowing the all other applications to be executed regardless of the amount of available battery power. The illustrated user-interface 310 provides for the user to access the critical/essential application (e.g., the application requiring reserve battery power) and re-configure the battery power threshold as need and/or as the situation dictates.

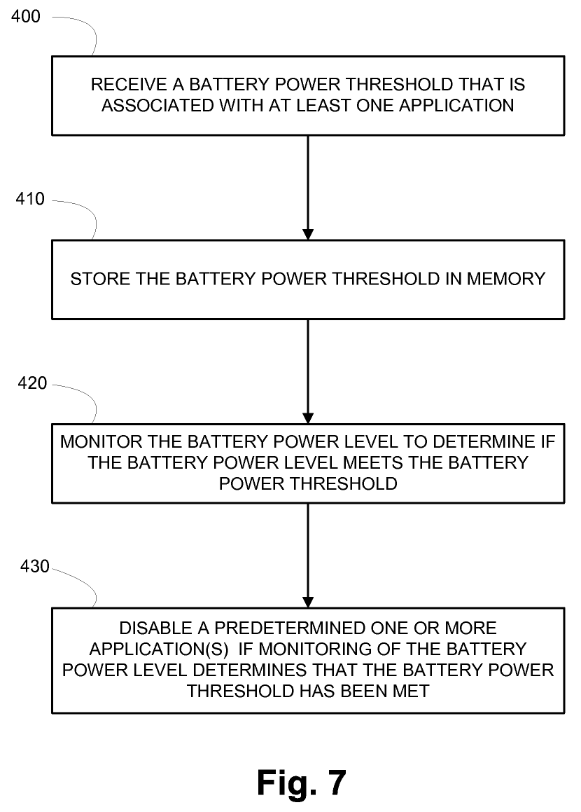

Referring to FIG. 7, a flow diagram is depicted of a method for limiting power consumption in a wireless communication device, in accordance with an aspect. At Event 400, a wireless communication device receives a battery power threshold that is each associated with at least one of a plurality of applications executed on the wireless device. In one aspect, the battery power threshold may be battery power limit threshold associated with one or more applications, such as power intensive applications including, for example, an audio/video player application, a video gaming application, an Internet browser application or the like. Additionally, in another aspect, the battery power threshold may be a reserve battery power threshold associated with one or more applications, such as an essential and/or critical application as determined by the device user and/or a third party, for example, including a communication call application or the like. The battery power threshold may be received by user configuration or the thresholds may be preconfigured by the service provider and/or the device manufacturer.

In addition to receiving a battery power threshold, the device may also receive one or more conditions associated with the threshold, such as geographic location, time or the like. A condition associated with a threshold may further limit the threshold from being met unless one or more of the predefined conditions are met.

At Event 410, the battery power threshold is stored in device memory. The battery power threshold may be stored within the associated application and/or communicated to a battery power monitor and stored in conjunction with the monitor.

At Event 420, the battery power level is monitored to determine if the battery power level meets the battery power threshold. Monitoring the battery power level may include polling a battery power monitor at predetermined intervals to determine the battery power level. Monitoring to determine if the battery power level meets the battery power threshold may further include monitoring of conditions, such as geographic location, time or the like, to determine if predefined conditions associated with the threshold have been met.

At Event 430, a predetermined one or more of the plurality of applications may be disabled if monitoring of the battery power level determines that the battery power threshold has been met and, in those aspects that utilize conditions, the conditions being met, as well. The disablement of the applications will occur without shutting down the wireless communication device. For example, in one aspect in which the threshold is associated with an essential and/or critical application, such as a communication call application, all non-essential/non-critical applications may be disabled. In another example, such as an alternate aspect in which the threshold is associated with a power intensive application, the power-intensive application associated with the threshold may be disabled. Disabling an application may include terminating an application that is currently executing and/or prohibiting the start of an application. Disablement of an application may persist until the battery power threshold exceeds the threshold, until the user reconfigures, adjusts or disables the threshold or until an alternative power source is used. In an alternate aspect, a user notification, such as a display of information or an audible signal, may be communicated once the threshold has been met but prior to the disablement of the application to alert the user that disablement is imminent.

As previously noted, disabling one or more applications once a threshold is met may further require one or more conditions to be met. For example, if the threshold additionally includes a condition, such as geographic location, a time or the like, the threshold may be required to be met while the device is located at the predetermined location, during the predefined time period or during the existence of any other predetermined condition.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Further, in some aspects, the steps and/or actions of a method or algorithm may reside as one or any combination or set of codes or instructions on a machine-readable medium and/or computer readable medium, which may be embodied in a computer program product.

Thus, present aspects define systems, methods and apparatus for limiting application power consumption and/or reserving power for essential applications that are executed on a wireless device. The present aspects provide methods, devices and systems that are highly user-configurable, in that, the user can define which applications require limiting battery power consumption and the amount of power that should be limited and/or which applications require reserving battery power and the amount of battery power that should be reserved. In this regard, present aspects prevent power intensive applications from consuming battery power to a level at which essential device functions, such as communication calls or the like, no longer have sufficient power to accommodate the function.

While the foregoing disclosure shows illustrative aspects and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for limiting power consumption in a wireless communication device, comprising:
receiving, at the wireless communication device, at least one battery power threshold, wherein each battery power threshold is associated with at least one of a plurality of applications executable on the wireless communication device;
storing the at least one battery power threshold in wireless communication device memory;
monitoring a battery power level of the wireless communication device to determine if the battery power level meets the at least one battery power threshold; and
disabling a predetermined one of the plurality of applications, while not shutting down the wireless communication device, if monitoring of the battery power level determines that the at least one battery power threshold has been met.

2. The method of claim 1, wherein receiving further comprises receiving at least one reserve power threshold, wherein each reserve power threshold is associated with a corresponding application executable on the wireless communication device having a predetermined power reserve.

3. The method of claim 2, wherein disabling further comprises disabling any currently executing application on the wireless communication device except for the application having the predetermined power reserve and any applications that support the application having the predetermined power reserve, if monitoring of the battery power level determines that the corresponding reserve power threshold has been met.

4. The method of claim 3, further comprising prohibiting starting all executable applications on the wireless device except for the application having the predetermined power reserve and any of the applications that support the application having the predetermined power reserve until the battery power level exceeds the reserve power threshold.

5. The method of claim 1, wherein disabling further comprises disabling the at least one application associated with the at least one battery power threshold.

6. The method of claim 1, wherein the predetermined one of the plurality of applications comprises a predetermined set of the plurality of applications exclusive of the at least one application associated with the at least one battery power threshold, wherein disabling further comprises disabling the predetermined set of the plurality of applications.

7. The method of claim 1, wherein receiving further comprises receiving at least one user-inputted, battery power threshold.

8. The method of claim 1, wherein the plurality of applications executable on the wireless communication device are chosen from the group consisting of an audio player application, a video player application, a multimedia player application, a broadcast media player application, a network browser application and a communication call application.

9. The method of claim 1, wherein receiving at least one battery power threshold further comprises receiving at least one percentage of a maximum battery power level.

10. The method of claim 1, wherein monitoring battery power level further comprises polling of a battery power monitor to determine the battery power level.

11. The method of claim 1, wherein disabling further comprises communicating an interrupt message from a battery power monitor to the predetermined one of the plurality of applications if monitoring of the battery power level determines that the at least one battery power threshold has been met.

12. The method of claim 1, wherein disabling further comprises prohibiting execution of the predetermined one of the plurality of applications until the battery power level exceeds the at least one battery power threshold.

13. The method of claim 1, further comprising adjusting the at least one battery power threshold to enable the predetermined one of the plurality of applications that has been previously disabled due to the battery power threshold being met.

14. The method of claim 1, further comprises communicating a warning prior to the disabling of the predetermined one of the plurality of applications, wherein the warning is operable to provide an alert that disablement of the predetermined one of the plurality of applications is imminent.

15. The method of claim 1, wherein disabling further comprises disabling all non-communication call-related applications.

16. The method of claim 1, wherein receiving further comprises receiving at least one predetermined location, and further comprising monitoring a location of the wireless communication device, wherein disabling further comprises disabling if both monitoring of the battery power level determines that the at least one battery power threshold has been met and if monitoring of the location of the wireless communication device determines that the location matches the at least one predetermined location.

17. The method of claim 1, wherein receiving further comprises receiving at least one predetermined time, and further comprising monitoring a time, wherein disabling further comprises disabling a predetermined one of the plurality of applications if both monitoring of the battery power level determines that the at least one battery power threshold has been met and if monitoring of the time determines that the time matches the at least one predetermined time.

18. At least one processor operable on a wireless communication device and configured to perform the actions of:
receiving, at the wireless communication device, at least one battery power threshold, wherein each battery power threshold is associated with at least one of a plurality of applications executable on the wireless communication device;
storing the at least one battery power threshold in wireless communication device memory;
monitoring a battery power level of the wireless communication device to determine if the battery power level meets the at least one battery power threshold; and
disabling a predetermined one of the plurality of applications, while not shutting down the wireless communication device, if monitoring of the battery power level determines that the at least one battery power threshold has been met.

19. A computer program product:
a computer readable medium comprising:
a first set of codes for causing a computer to receive, at a wireless communication device, at least one battery power threshold, wherein each battery power threshold is associated with at least one of a plurality of applications executable on the wireless communication device;
a second set of codes for causing the computer to store the at least one battery power threshold in wireless communication device memory;
a third set of codes for causing the computer to monitor a battery power level of the wireless communication device to determine if the battery power level meets the at least one battery power threshold; and
a fourth set of codes for causing the computer to disable a predetermined one of the plurality of applications, while not shutting down the wireless communication device, if monitoring of the battery power level determines that the at least one battery power threshold has been met.

20. A wireless communication device, comprising:
means for receiving, at a wireless communication device, at least one battery power threshold, wherein each battery power threshold is associated with at least one of a plurality of applications executable on the wireless communication n device;
means for storing the at least one battery power threshold in wireless communication device memory;
means for monitoring a battery power level of the wireless communication device to determine if the battery power level meets the at least one battery power threshold; and
means for disabling a predetermined one of the plurality of applications, while not shutting down the wireless communication device, if monitoring of the battery power level determines that the at least one battery power threshold has been met.

21. A wireless communication device, comprising:
a computer platform including a processor and a memory;
a plurality of applications stored in the memory and executable by the processor;
a battery power monitor executable by the processor and operable to monitor a battery power level of the wireless communication device; and
a battery power threshold module, in communication with the battery power monitor, stored in the memory and executable by the processor, wherein the battery power threshold module is operable to receive a battery power threshold associated with at least one of the plurality of applications, determine if the battery power level meets the battery power threshold, and disable a predetermined one of the plurality of applications, while not shutting down the device, if the battery power level meets the battery power threshold.

22. The device of claim 21, wherein the predetermined one of the plurality of applications further comprises the at least one of the plurality of applications associated with the battery power threshold.

23. The device of claim 21, wherein the predetermined one of the plurality of applications comprises a predetermined set of the plurality of applications exclusive of the at least one of the plurality of applications associated with the battery power threshold, and wherein the battery power threshold module is operable to disable the predetermined set of the plurality of applications.

24. The device of claim 21, wherein the battery power threshold module is further operable to receive a reserve power threshold associated with one of the plurality of applications having a predetermined power reserve, determine if the battery power level meets the reserve power threshold and disable any currently executing application on the wireless communication device except for the one application having the predetermined power reserve and any applications that support the one application having the predetermined power reserve, while not shutting down the wireless communication device, if monitoring of the battery power level determines that the battery power level meets the associated reserve power threshold.

25. The device of claim 24, wherein the battery power threshold module is further operable to prohibit execution of each of the plurality of applications on the wireless device except for the one application having the power reserve and any of the applications that support the one application having the power reserve until wireless device power exceeds the reserve power threshold.

26. The device of claim 21, wherein the battery power threshold module further comprises a user interface operable to allow a user to input the battery power threshold.

27. The device of claim 21, wherein the predetermined one of the plurality of applications further comprises an application chosen from the group consisting of an audio player application, a video player application, a multimedia player application, a broadcast media player application, a network browser application and a communication call application.

28. The device of claim 21, wherein the battery power threshold module is further operable to poll the battery power monitor to determine the battery power level.

29. The device of claim 21, wherein the battery power monitor is operable to generate an interrupt message if monitoring of the battery power level determines that the battery power threshold has been met, and wherein the battery power threshold module is further operable to receive the interrupt message and thereby determine that the battery power level meets the battery power threshold.

30. The device of claim 21, wherein the battery power threshold module is further operable to provide for readjustment of the at least one battery power threshold to re-initiate the predetermined one of the plurality of applications that has been previously disabled.

31. The device of claim 21, wherein the battery power threshold module is further operable to generate a warning prior to disabling the predetermined one of the plurality of applications, wherein the warning is operable to provide an alert for a wireless communication device user that disablement of the predetermined one of the plurality of applications is imminent.

32. The device of claim 21, wherein the battery power threshold module is further operable to prohibit execution of the predetermined one of the plurality of applications until wireless device power exceeds the at least one battery power threshold.

33. The device of claim 21, further comprising a geographic position locating device executable by the processor to determine a location, wherein the battery power threshold module is further operable to receive a predetermined location associated with the battery power threshold, wherein the battery power threshold module is further operable to associate the location with the battery power threshold, and disable the predetermined one of the plurality of applications if the battery power level meets the battery power threshold when the location matches the predetermined location.

34. The device of claim 21, further comprising a clock device executable by the processor to generate a time, wherein the battery power threshold module is further operable to receive a predetermined time associated with the battery power threshold and disable the predetermined one of the plurality of applications if the battery power level meets the battery power threshold when the time matches the predetermined time.
